(19) United States
(12) Patent Application Publication
(10) Pub. No.: US 2013/0138544 A1
(43) Pub. Date: May 30, 2013

(54) SYSTEM AND METHOD FOR CREATING FINANCIAL TOOLS

(71) Applicant: Chris Chapman, Moonee Ponds (AU)

(72) Inventor: Chris Chapman, Moonee Ponds (AU)

(73) Assignee: INFOSYS LIMITED, Bangalore, Karnataka (IN)

(21) Appl. No.: 13/814,488

(22) PCT Filed: Aug. 6, 2010
(86) PCT No.: PCT/IN10/00524

§ 371 Date: Feb. 5, 2013

(51) Int. Cl. G06Q 40/00

(52) U.S. Cl. CPC G06Q 40/00
USPC 705/35

(57) ABSTRACT

A system and method for developing a financial tool is provided. The system is an enterprise level framework. The system for developing a financial tool includes a User Interface Module, a Component Module, a Business Logic Layer Module, and an Application Programming Interface (API). The User Interface Module is configured to develop a user interface of a financial tool, based on the requirements of a business solution. The Component Module is configured to define the structure and the function of the user interface of the financial tool being developed, based on the requirement of the business solution. The Business Logic Layer Module is configured to process data in the financial tool, based on the requirement of the business solution. The API is configured to retrieve data from an end-user or an external data source to further process the retrieved data based on the requirement of the business solution.

### FIELD OF INVENTION

The present invention relates to a financial tool. More particularly, the present invention provides an enterprise level framework to build financial tools.

### BACKGROUND OF THE INVENTION

Financial corporations are integrating business processes with technology to efficiently capitalize their services and in turn nurture productivity. Business/financial tools have been developed to help users process their financial details efficiently. For example, a financial corporation provides various financial calculators, such as a loan repayment calculator, enabled on its website to help its client to perform competitive quantitative analysis of installment payable for a particular amount taken for a predetermined period of time.

Presently, a developer creates a business tool for a respective set of business task with the help of various Application Programming Interfaces (APIs) such as Swing, Adobe Flex APIs, based on the requirement of the financial tool. For example, in order to create a business tool (interest calculator), the developer gathers all the input and output parameters required to develop a tool. Thereafter, the developer designs the user interface of the business tool based on the requirement of the user. And finally, the developer defines the sequence of steps required to process a particular transaction involving various computations, which need to be performed at the business tool. However, the abovementioned methodology suffers from the disadvantage that each time a new business requirement is received, the developer has to start building a business application (for the received requirement) from scratch. Further, to cater to a business requirement a trained professional is required each time to develop a business tool/application, which is an expensive alternative in terms of both cost and effort.

Furthermore, since the business tools are not created on a unified level framework, they cannot be integrated into any other, financial software. Also, the framework presently used to create the business tools do not commonly feature ‘locale’ attribute, such as multi-lingual support, multi-currency support, accessibility support and the like. This in turn, restricts global implementation of the business tools available in various financial corporations.

Moreover, the business tools implemented in a financial corporation are ‘FORM’ based, i.e. a user of the business tool/financial application is required to press an execute button to get the desired output. This in turn, restricts the user to carry out real-time/dynamic analysis of the product using various quantitative factors. For example, in case a user is comparing a car loan scheme offered by two competitive financial corporations, the user checks various fluctuation of both principal as well as interest data points to decide which product suites his need the best. Since, the car loan calculator is form based, the user has to re-select/alter each value from the list of quantitative constraints (loan amount, payment term etc) and subsequently press the execute button to further process the data, thereby making his experience cumbersome and repetitive. Moreover, most of the business calculators are restricted to present the processed data textually, which does not allow the user to have a holistic view of his financial liabilities.

In light of the abovementioned disadvantages, there is a need for a method and a system to provide an enterprise level framework to create a business/financial tool incorporating real-time analysis and generating graphical summary of the processed data. Further, there is a need to include ‘locale’ features in the business/financial tool to enable its global utility.

### SUMMARY OF THE INVENTION

A system and method for developing a financial tool is provided. The system, an enterprise level framework, for developing a financial tool includes a User Interface Module, a Component Module and a Business Logic Layer Module. The User Interface Module is configured to develop a user interface of the financial tool, based on the requirements of a business solution. The Component Module is configured to define the structure and the function of the user interface of the financial tool being developed, based on the requirement of the business solution. The Business Logic Layer Module is configured to process data in the financial tool, based on the requirement of the business solution.

In an embodiment of the present invention, the User Interface Module is further configured to select a layout for a user interface of the financial tool being developed, from one or more pre-stored layouts, based on the requirement of the business solution.

In an embodiment of the present invention, the layout of the user interface selected from the one or more pre-stored layouts comprising at least one of an Input Panel, an Output Panel and an Output Summary Panel. The Input Panel is configured to receive input data from an end-user to further execute computation in the financial tool. The Output Panel is configured to display the processed output/data of the received input data based on the requirement of the business solution. The Output Summary Panel is configured to display a summary/outline output based on at least one of the processed output/data of the received input data and the requirement of the business solution.

In an embodiment of the present invention, the Component Module, configured to define the structure and the function of the user interface of the financial tool being developed, comprises a Loader Component, a Slider Component, a NavBar Component, a Chart Component, a Dialog window Component, and a Dropdown Component. The Loader Component is configured to load one or more programs associated with the financial tool and one or more other components associated with the financial tool. The Slider Component is configured to enable an end-user to select an input value with the help of predefined indicators outlined in a graphical user interface bar, wherein each of the indicators corresponds to a predefined value. The NavBar Component is configured to implement navigation functionality in the financial tool. The NavBar Component comprises one or more address links of various parts of the financial tool. The Chart Component is configured to render graphical representation of the processed data computed in the financial tool. The Dialog window Component is configured to implement a popup window used for at least one of, to display communication information to an end-user and to prompt an end-user to input a response. The Dropdown Component configured to enable the end-user to select an input value from a list of input values displayed in the financial tool.

In various embodiment of the present invention, the Component Module is further configured to link at least one component selected from the Component Module to the user interface of the financial tool being developed based on the requirements of the business solution.

In an embodiment of the present invention, the Business Logic Layer Module, configured to process data in the financial tool, comprises a Scenario Class, a Simulator Class, and a Result Class. The Scenario Class is configured to fetch and encapsulate one or more input values required to execute computation in a financial tool being developed. The Simulator Class is configured to perform computational simulation on the encapsulated one or more input values based on the requirement of the business solution. The Result Class is configured to encapsulate at least one output of the computed data in the financial tool.

In an embodiment of the present invention, the Business Logic Layer Module further comprises one or more objects. Each of the one or more objects is configured to interact with one or more classes, selected from a Domain Class Module to process the data in the financial tool, based on the requirement of the business solution. The one or more classes selected from the Domain Class Module define methodology of computational functions used by the financial tool.

In an embodiment of the present invention, the system further comprises a Domain Class Module. The Domain Class Module is configured to define the methodology of various computational functions used in the financial tool to further process data, based on the requirement of the business solution.

In an embodiment of the present invention, the Domain Class Module comprises a Repayment Class, a Withdrawal Class, an Interest Class, an Account Class, a Transaction Class, and a Projection Class. The Repayment Class is configured to encapsulate information/data corresponding to a repayment and it further defines the methodology to perform the repayment during computation performed in the financial tool. The Withdrawal Class is configured to encapsulate information/data corresponding to a withdrawal and it further defines the methodology to perform the withdrawal during computation performed in the financial tool. The Interest Class is configured to encapsulate information/data corresponding to an interest and it further defines the methodology to perform at last one of interest transaction and interest calculation during computation performed in the financial tool. The Account Class is configured to encapsulate the present state of an account at a predetermined instance of time. The Transaction Class is configured to encapsulate information/data corresponding to a transaction and it further defines the methodology to perform the transaction during computation performed in the financial tool. The Projection Class is configured to encapsulate a record of financial activities.

In an embodiment of the present invention, each of the classes included in the Domain Class Module is selected based on a respective functional requirement of the financial tool, defined by the requirement of the business solution.

In an embodiment of the present invention, the system further comprises an Application Programming Interface (API). The Application Programming Interface (API) is configured to retrieve data from at least one of input data provided by an end-user and received data from an external data source, to further process the retrieved data in the financial tool, based on the requirement of the business solution.

In an embodiment of the present invention, the Application Programming Interface (API) is a JavaScript API.

In an embodiment of the present invention, the Application Programming Interface (API) is further configured to enable a developer to embed the financial tool into one or more financial tools being developed.

In another embodiment of the present invention, the system for developing a financial tool includes a User Interface Module, a Component Module, a Business Logic Layer Module, and an Application Programming Interface (API). The User Interface Module is configured to develop a user interface of a financial tool, based on the requirements of a business solution. The Component Module is configured to define the structure and the function of the user interface of the financial tool being developed, based on the requirement of the business solution. The Business Logic Layer Module is configured to process data in the financial tool, based on the requirement of the business solution. The Application Programming Interface (API) is configured to retrieve data from at least one of input data provided by an end-user and received data from an external data source, to further process the retrieved data in the financial tool, based on the requirement of the business solution.

In an embodiment of the present invention, the method to develop a financial tool in an enterprise level framework includes receiving one or more parameters from a business requirement document (BRD). The BRD describes the structural and functional attributes of the financial tool being developed. After which, user interface development sequence is initiated, based on the received one or more parameters. Thereafter, one or more components are linked to the financial tool. The one or more components defines a functional and structural attribute of the financial tool, based on the received one or more parameters. Subsequently, a method to process data in the financial tool is defined, based on the received one or more parameters.

In an embodiment of the present invention, the one or more parameters comprises at least one of a set of input/output parameters based on the requirement of the financial tool being developed, the functional requirements of the financial tool being developed, and the structural layout of the financial tool being developed.

In an embodiment of the present invention, the method to develop a financial tool in an enterprise level framework further includes selecting a layout of a predefined user interface based on the received one or more parameters corresponding to the financial tool being developed. Thereafter, each of the one or more components is linked to the selected layout of the user interface based on the received one or more parameters corresponding to the financial tool being developed.

In an embodiment of the present invention, defining the method to process data in the financial tool further comprises selecting one or more predefined computational methodologies, based on the requirement of the business solution.

### BRIEF DESCRIPTION OF THE ACCOMPANYING DRAWINGS

The present invention is described by way of embodiments illustrated in the accompanying drawings wherein:

FIG. 1 is a block diagram of a system employed to develop a financial tool, in accordance with an embodiment of the invention;

FIG. 2 is a block diagram of a user interface module employed to develop a financial tool in an enterprise level framework, in accordance with an embodiment of the invention;

FIG. 3 is a block diagram of a component module used to develop a financial tool in an enterprise level framework, in accordance with an embodiment of the invention;

FIG. 4 is a block diagram of a business logic layer module used in a financial tool being developed in an enterprise level framework, in accordance with an embodiment of the invention;

FIG. 5 is a block diagram of a domain class module used to develop a financial tool in an enterprise level framework, in accordance with an embodiment of the invention;

FIG. 6A and 6B illustrate a flowchart to develop a financial tool in an enterprise level framework, in accordance with an embodiment of the invention; and

FIG. 7 illustrates a screenshot of a financial tool developed in the enterprise level framework, as an exemplary output of the present invention.

### DETAILED DESCRIPTION OF THE INVENTION

A system and method that provides an enterprise level framework to develop a financial tool, based on the requirement of a business solution. The invention facilitates a platform to develop financial tool in various programming languages/technologies such as Java, Flash and so forth. Further, the invention facilitates development of a financial tool from a predefined layout of a financial tool, reducing the cost and effort incurred in developing the financial tool. Furthermore, the invention facilitates the development of a financial tool in a unified enterprise level framework, which in turn enables seamless transition of a developed financial tool to other technologies. In addition, the invention facilitates real-time analysis of a computation at a financial tool, wherein the corresponding output of the financial tool is generated as soon as any one of the input parameters is changed. Moreover, the invention facilitates the end-user to have a holistic view of the processed data through graphical projection of the processed data. Also, the invention facilitates the implementation of the ‘locale’ feature in the financial tool developed at the enterprise level framework, enabling global implementation of the financial tool.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

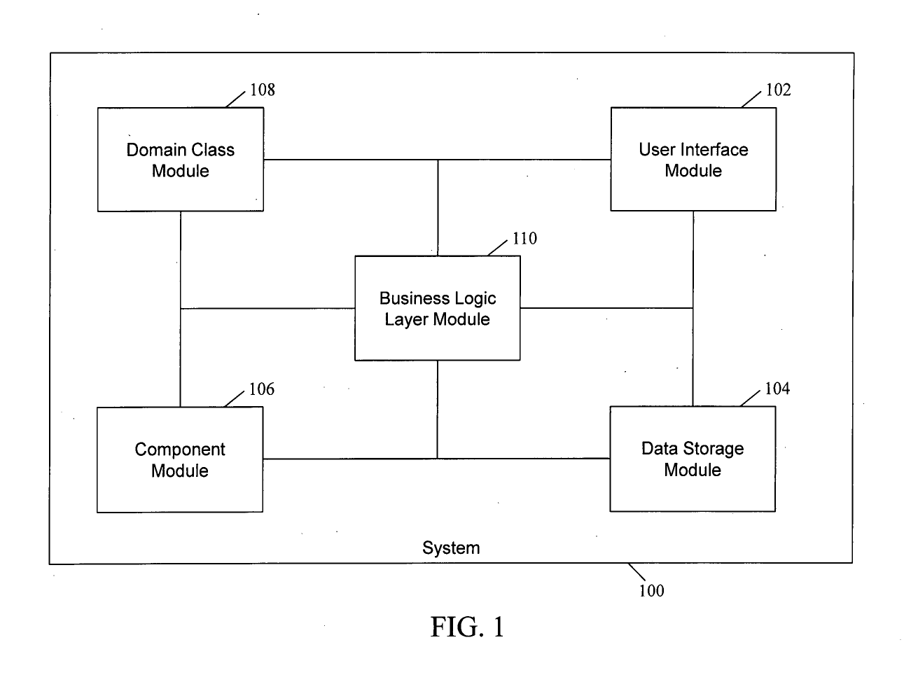

FIG. 1 is a block diagram of a system employed to develop a financial tool, in accordance with an embodiment of the invention. The system 100 includes a User Interface Module 102, a Data Storage Module 104, a Component Module 106, a Class Module 108 and a Business Logic Layer Module 110.

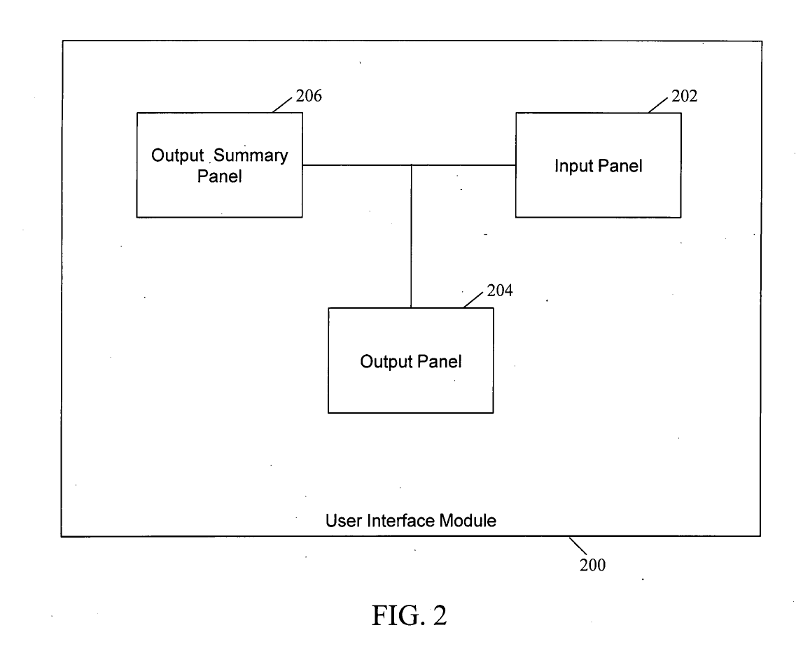

The User Interface Module 102 provides a front-end interface to a developer to develop a business/financial tool in various embodiment of the present invention. A user interface/graphical environment can be further defined as a point of communication between a user/client and computing elements of the system 100. Moreover, it provides an interface between a developer and the framework to model user interface and other associated functionalities of a business solution (financial tool). In an embodiment of the present invention, a developer when designing a financial tool in the enterprise level framework is enabled to design the various sections of the user interface, such as input segment, output segment and so forth, with the aid of the User Interface Module 102. Primarily, the User Interface Module 102 creates a predetermined structure of the user interface to be used in a financial tool. For example, in case of a ‘loan repayment calculator’, the User Interface Module 102 describes the user interface with an input segment, an output segment and an output summary segment. It may be apparent to a person skilled in the art that various alteration of the user interface may be performed based on the functionality of a financial tool. The User Interface Module 102 is further explained in FIG. 2.

The Data Storage Module 104 is used to store various predefined data such as security parameters, default input and output parameters, default input values, mathematical constants, mathematical calculation methodologies and so forth, which in turn are used by the system 100 to create a financial tool. In an embodiment of the present invention, the system 100 performs several security checks to authorize the development of a financial tool/application. In another embodiment of the present invention, the system 100 enables security checks to be performed at the instance when the financial tool is invoked by a user. The methodology to perform security check utilizes predefined security check parameters stored in the Data Storage Module 104. The predefined security check parameters are further stored as a policy file. In an exemplary embodiment of the present invention a policy file titled ‘policy.html’ stores security setting of an interest calculator (financial tool), which in turn are verified/validated at the time when the user initiates the interest calculator.

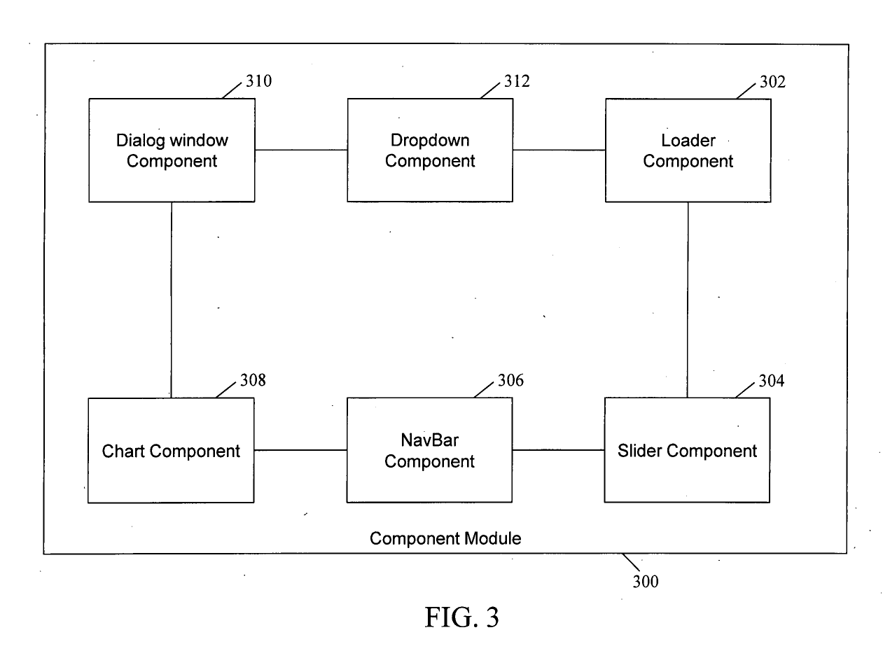

The Component Module 106 is the primary building block used to define the structure and the functionality of the system 100. Each component selected from the Component Module 106 performs a set of defined functions. Alternately, two or more components may be used to execute a specified task. For example, an online checkout process can be primarily divided into two parts, the first is to process the payment (via suitable card) and the second is to complete the checkout on successful execution of the payment process. Thus, two components are designed to perform both the respective functions individually, a checkout component and a card processing component. Each of the two components performs a predefined set of action to complete the given process. At first, the card processing component processes the payment by performing predefined set of action/function. On completing the execution of the card processing component, it triggers the check out component to finalize the checkout process. Furthermore, the components selected from the Component Module 106 may be used to develop interactional elements, such as a button, slider and so forth, in the user interface of a financial tool. The Component Module 106 is further explained in conjunction with FIG. 3.

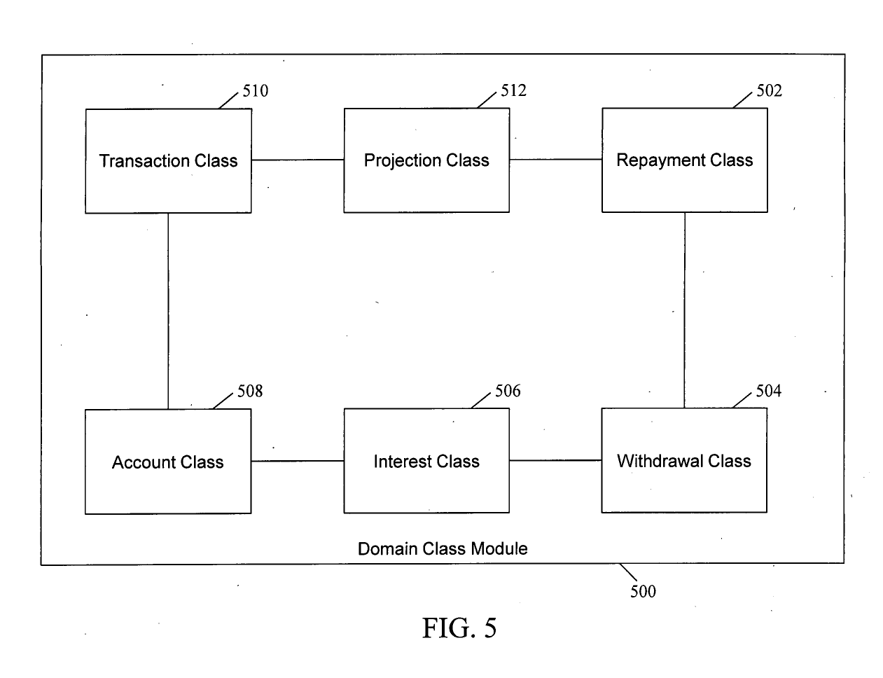

The Domain Class Module 108 includes classes, employed to define logical structure of the required components in a financial tool, which is being developed. The classes selected from the Domain Class Module 108 acts as a blueprint of a component used for a specific functionality in the financial tool. A class defines a methodology which is employed to achieve a desired functionality/outcome from its component. In an exemplary embodiment of the present invention, the class selected from the Domain Class Module 108 is designed based on the functionalities required from a financial tool/application. For example, in case a class is required to add two integer values, the class is defined with steps such as receive two respective integers, identify the type of number and add the received numbers. The Domain Class Module 108 is further explained in conjunction with FIG. 5.

In various embodiments of the present invention, the Business Logic Layer Module 110 enables a financial tool being developed to process data in conjunction with one or more classes selected from the Domain Class Module 108.

In an embodiment of the present invention, a business logic layer module 110 is developed respectively for each of the financial tools being developed at the enterprise level framework, based on the requirements of their corresponding business solutions.

In an embodiment of the present invention, software architecture such as Model View Controller (MVC) architecture is used as a framework for a financial tool being developed. The MVC architecture includes three primary segments: a model, which manages data and updates a user interface of the financial tool, based on any updated/processed information corresponding to each of one or more functional elements deployed in the financial tool; a controller, which is responsible to receive input data provided in the user interface and further updates the model based on the received input; and a view, which in turn is a functional element placed in the user interface of the financial tool to further render the processed/updated information derived from the model.

The Business Logic Layer Module 110 interacts with a model (data storage) to perform necessary computation based on the requirement of the business solution. In an exemplary embodiment of the invention, the model may be the Data Storage Module 104, which in turn is configured to store updated information corresponding to each of the functional elements created in the user interface of the financial tool being developed.

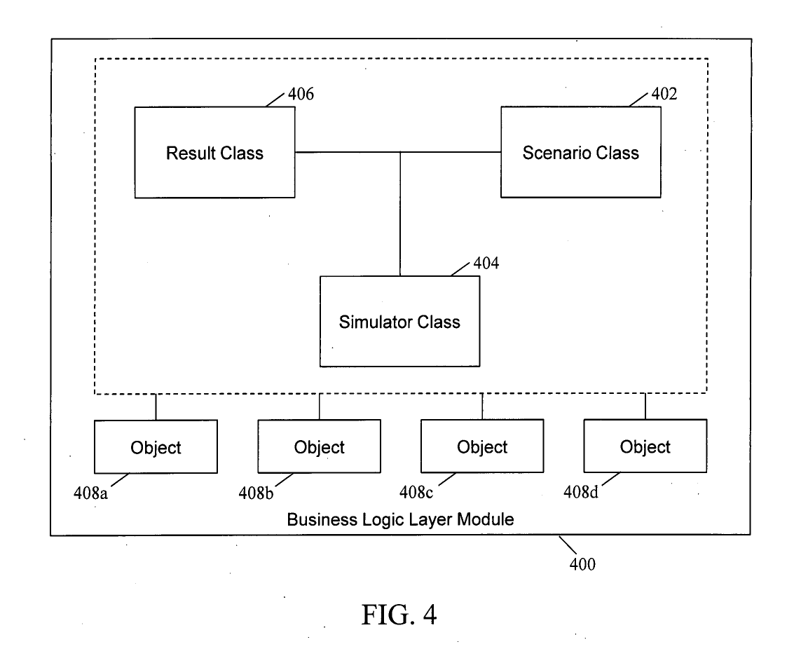

Further, the Business Logic Layer Module 110 utilizes one or more classes selected from the Domain Class Module 108, to perform various computations in the financial tool, based on the requirement of the business solution. The processed data is thereafter transferred to the model (Data Storage Module 104), which in turn in conjunction with one or more controllers update the corresponding functional elements rendering the output data in the user interface of the financial tool. The Business Logic Layer Module 110 is further explained in conjunction with FIG. 4.

FIG. 2 is a block diagram of a user interface module employed to develop a financial tool in an enterprise level framework, in accordance with an embodiment of the invention. The User Interface Module 200 facilitates a developer to define a layout and corresponding functionalities of a user interface for a financial tool based on the requirement of a business solution.

In an embodiment of the present invention, the User Interface Module 200 provides an interface between the developer and the enterprise level framework, which in turn facilitates the developer to develop a financial tool based on the requirements of a business solution. In another embodiment of the present invention the User Interface Module 200 generates a list of functional elements, wherein each of the functional elements may be inserted in the financial tool being developed based on the requirement of the business solution. In yet another embodiment of the present invention, the User Interface Module 200 enables a drag and drop feature to insert a functional element in the financial tool being developed. In yet another embodiment of the present invention, the User Interface Module 200 provides one or more predefined layouts of a user interface to be incorporated in a financial tool. A developer selects a layout of a user interface from the one or more predefined layouts of the user interface, to develop a financial tool, based on the requirement of a business solution. In an embodiment of the present invention each of the one or more predefined layouts includes an Input Panel 202, an Output Panel 204, and an Output Summary Panel 206. It may be apparent to a person skilled in the art that various other modification may be made to the layout of the user interface based on the requirement of a financial tool. Further, various tools other than a financial tool may be developed using the enterprise level framework.

In an embodiment of the present invention, the Input Panel 202 represents a section of the user interface at which an end-user/client using the tool/application would provide its input to the financial tool for further processing. Subsequently, the Output Panel 204 of the user interface represents a section at which the developed tool provides the processed output of the received data based on the functionality of the financial tool. Thereafter, the Output Summary Panel 206 of the user interface represents a section of the user interface at which the financial tool provides a summary/outline output based on the processed output of the received data and the functionality of the financial tool/application.

The User Interface Module 200 further enables a developer to select various components included in the component module 106 (FIG. 1) based on the functionality required at the respective panels in the user interface layout. After which, each of the selected components is linked to its respective panel in the user interface to execute the required predetermined functionality of the panel. It may be apparent to a person skilled in the art that various other panels may be incorporated in the user interface to enable an end-user to perform complex calculation based on the requirement of a business solution.

In an exemplary embodiment of the present invention, a slider component is linked to the Input Panel 202 to receive an input value from an end-user, wherein the slider is operated by the end-user. Similarly, a chart component is linked to the Output Panel 204 to present the processed output (result of the computation performed at the developed financial tool) to the end-user. It may be apparent to a person skilled in the art that various components may be linked to respective panels based on the functionality required at each of the panels, which are designed for a particular business solution. The components selected from the Component Module 106 (FIG. 1) to be linked to respective panels of a user interface are further explained in conjunction with FIG. 3.

FIG. 3 is a block diagram of a component module used to develop a financial tool in an enterprise level framework, in accordance with an embodiment of the invention. The Component Module 300 includes a Loader Component 302, a Slider Component 304, a NavBar Component 306, a Chart Component 308, a Dialog Window Component 310, and a Dropdown Component 312.

A component selected from the Component Module 300 defines the structural and functional attribute of a financial tool/application being developed at the enterprise level framework. Each of the components selected from the Component Module 300 performs a predetermined function/action in the financial tool. In various embodiment of the present invention, the Loader Component 302 is the primary component which is required in every financial tool/application developed at the enterprise level framework. The Loader Component 302 loads either programs/instances to be executed or one or more components associated with the tool/application. In various embodiment of the present invention, the Loader Component 302 invokes various components and extracts predefined data required for the initialization of the financial tool. In an exemplary embodiment of the present invention, when a financial tool is initiated by an end-user, the Loader Component 302 renders a default screen to the end-user. Subsequently, the Loader Component 302 initiates one or more components linked with the developed user interface of the financial tool. After invoking all the required components, the Loader Component 302 retrieves predefined default data and security settings stored in the Data Storage Module 104 (FIG. 1). Thereafter, the Loader Component 302 renders the user interface of the developed financial tool.

The Slider Component 304 is an interactive graphical user interface bar with predefined indicators, wherein each of the indicators is associated with a default numeric value. The Slider Component 304 is used by an end-user to input data, which is utilized by a financial tool for further processing. For example, a Slider Component 304 may be implemented in a ‘loan calculation tool’ to select the amount of loan required. Each of the indicators aligned on the bar, in the Slider Component 304, is associated with a predefined value mapped in an ascending order for a predefined range of value (US $50,000 to US $400,000).

The NavBar Component 306 implements navigation functionality in a financial tool. The NavBar (Navigation Bar) Component 306 (also known as a links bar or link bar) is a sub region of a financial tool that contains one or more address links, which in turn enables an end-user to navigate between various parts of the financial tool. In an embodiment of the present invention, the NavBar Component 306 enhances the usability as well as the visual attractiveness of the financial tool.

The Chart Component 308 renders graphical/pictorial representation of the processed input data based on financial calculations executed in the financial tool. Further, the Chart Component 308 may be predefined with various representation models/types, each of which is defined for a particular chart type to express the processed data, such as a Pie-Chart model, a Bar-Chart model and so forth.

The Dialog Window Component 310 implements a popup window, which in turn may be used for at least one of to display communication information to an end-user, to prompt an end-user to input a response.

The Dropdown Component 312 is used to select an input value from a list of input values, required for processing in the financial tool. For example, in case of a loan repayment calculator, the Dropdown Component 312 is linked to the input panel of the user interface, to receive a value for ‘repayment frequency’. It will be apparent to a person skilled in the art that various other components may be implemented based on the functionality of the tool/application being developed at the enterprise level framework.

FIG. 4 is a block diagram of a business logic layer module used in a financial tool being developed in an enterprise level framework, in accordance with an embodiment of the invention. The Business Logic Layer Module 400 facilitates computation of data in the financial tool, based on the requirements of the business solution. In various embodiment of the present invention, the Business Logic Layer Module 400 includes a Scenario Class 402, a Simulator Class 404, and a Result Class 406.

In various embodiment of the present invention, a Business Logic Layer Module 400 is incorporated in each of the financial tools developed at the enterprise level framework. The Business Logic Layer Module 400 enables a developed financial tool to process data based on a business solution implemented in the financial tool.

The Scenario Class 402 fetches and encapsulates all input values required to perform various computations at a financial tool being developed. In an embodiment of the present invention, various methods within the class are implemented to perform calculation. As soon as the financial tool is initiated by an end-user to process a data, the Scenario Class 402 is updated with input values required for computation, wherein the input values are derived from a data storage, such as the Data Storage Module 104 (FIG. 1). In an embodiment of the present invention, the developer defines various variables required to process a data at a financial tool. Once an end-user invokes a financial tool, the input data/values required for processing are fetched from the data storage by one or more controller assigned to each of the functional elements deployed in the user interface of the tool being developed. In another embodiment of the present invention the input values are provided by the end-user using the developed financial tool, wherein the one or more controllers assigned to each of the functional elements of the user interface receives the end-user's input and correspondingly updates the data storage associated with the developed financial tool. In an exemplary embodiment of the present invention, the developer builds a ‘loan repayment calculator’ at the enterprise level framework. The Scenario Class 402 is thereafter implemented at the tool to fetch input data, such as loan amount, loan term, loan interest and so forth, which in turn are required for computation in the financial tool.

The Simulator Class 404 implements a methodology to process the input data in conjunction with one or more classes selected from the Domain Class Module 108 (FIG. 1), based on the requirement of the business solution. In an embodiment of the present invention, after the Scenario Class 402 encapsulates all the input data required for processing, the Simulator Class 404 creates one or more Objects 408a-408d, such as transaction domain Object, a cash flow domain Object, a payment domain Object, an interest domain Object, a lump sum domain Object, and so forth, in conjunction with a service class to further process the encapsulated input data. After which, the created one or more Objects 408a-408d, based on the requirement of the developed financial tool, are populated with initial values encapsulated by the Scenario Class 402. Subsequently, the one or more Objects 408a-408d interact with corresponding one or more classes, selected from the Domain Class Module 108 (FIG. 1), to further process the input data.

In an exemplary embodiment of the present invention, in an ‘interest calculator/tool’, after the Scenario Class 402 encapsulates the input data provided at the user interface of the tool, the Simulator Class 404 creates one or more Objects 408a-408d, such as an interest domain Object, to further process the input data. Then, the Simulator Class 404 loads the created one or more Objects 408a-408d with initial values encapsulated by the Scenario Class 402. Thereafter, the simulator class 404 invokes a methodology/method steps included in the selected one or more classes, such as an interest class, to process the data in conjunction with the created one or more Objects 408a-408d at the interest calculator.

The Result Class 406 encapsulates the output of the processed data in the financial tool. In an exemplary embodiment of the present invention, the Result Class 406 encapsulates all the calculation values, such as amortization schedules, output of each individual calculation performed in the financial tool, and indicator variables. Once the processing of the fetched input data in the financial tool based on the requirement of the business solution is accomplished, the output of the computation is encapsulated by the Result Class 406. For example, an ‘interest calculator’ fetches input data, such as amount, time period and so forth, and after processing the input data, the output of the computed data (calculated interest) is encapsulated by the Result Class 406.

FIG. 5 is a block diagram of a domain class module used to develop a financial tool in an enterprise level framework, in accordance with an embodiment of the invention. The Domain Class Module 500 includes a Repayment Class 502, a Withdrawal Class 504, an Interest Class 506, an Account Class 508, a Transaction Class 510, and a Projection Class 512. It may be apparent to a person skilled in the art that various other classes may be developed based on the requirement of the business solution.

The Repayment Class 502 encapsulates information/data corresponding to the repayment, such as frequency of repayment, amount of repayment and so forth. The Repayment Class 502 further defines a methodology to perform the repayment during the simulation, invoked by the Simulator Class 404 (FIG. 4). In an exemplary embodiment of the present invention, in a loan repayment calculator, the amount of repayment is calculated by the Simulator Class 404 (FIG. 4) in conjunction with the Repayment Class 502.

The Withdrawal Class 504 encapsulates information/data corresponding to the withdrawal, such as frequency of withdrawal, amount of withdrawal, and so forth. The Withdrawal Class 504 further defines a methodology to perform the withdrawal during the simulation, invoked by the Simulator Class 404 (FIG. 4).

The Interest Class 506 encapsulates information/data corresponding to the interest. The Interest Class 506 further defines a methodology to perform at least one of interest transaction and interest calculation during the simulation, invoked by the Simulator Class 404 (FIG. 4).

The Account Class 508 encapsulates the present state of an account at a predetermined instance of time. In an exemplary embodiment of the present invention, the total amount available, in an end-user's account at a particular instance of time is calculated by the Simulator Class 404 (FIG. 4) in conjunction with the Account Class 508.

The Transaction Class 510 encapsulates information/data corresponding to the transaction. The Transaction Class 510 further defines a methodology to perform the transaction during the simulation, invoked by the Simulator Class 404 (FIG. 4). In an embodiment of the present invention the Transaction Class 510 may be used in conjunction with each of the one or more classes selected from the Domain Class Module 500, to implement respective calculation methodologies.

The Projection Class 512 encapsulates a record of financial activities. Further, the user interface in conjunction with the projection class 512 displays the processed information to the end-user using the developed financial tool.

It may be apparent to a person skilled in the art that each of the one or more classes included in the Domain Class Module 500 may include methodology to perform predetermined calculation. Further two or more classes included in the Domain Class Module 500 may collectively include methodology to perform predetermined calculation.

In various embodiments of the present invention, an enterprise level framework is enabled to create financial tools in various programming languages such as Java, Flash and so forth. The enterprise level framework further utilizes Java Foundation Classes (JFC) and Adobe Flex framework to create the Java based financial tool and the Flash based financial tool respectively. In an exemplary embodiment of the present invention, an Application Programming Interface (API), FAPI, is employed to integrate external system to the financial tool. The FAPI is a JavaScript API that can interact with the financial tool being developed, to push external parameters of the financial tool being developed into the tool. The API provides a methodology to set all variables used by the financial tool and subsequently retrieve all values either entered or calculated in the financial tool. Further, a developer of an external system, using the API, is enabled to embed a financial tool in a page of another financial tool being developed. Furthermore, the API enables interaction between the financial tools to perform the required modeling. In an exemplary embodiment of the invention, a ‘Loan Repayment Calculator’ could be embedded within a ‘Loan origination system’ to display to an end-user a graphical representation of the amortization schedule for the loan. Furthermore the end-user is enabled to fine tune the amount or term of the loan being proposed based on his/her requirement.

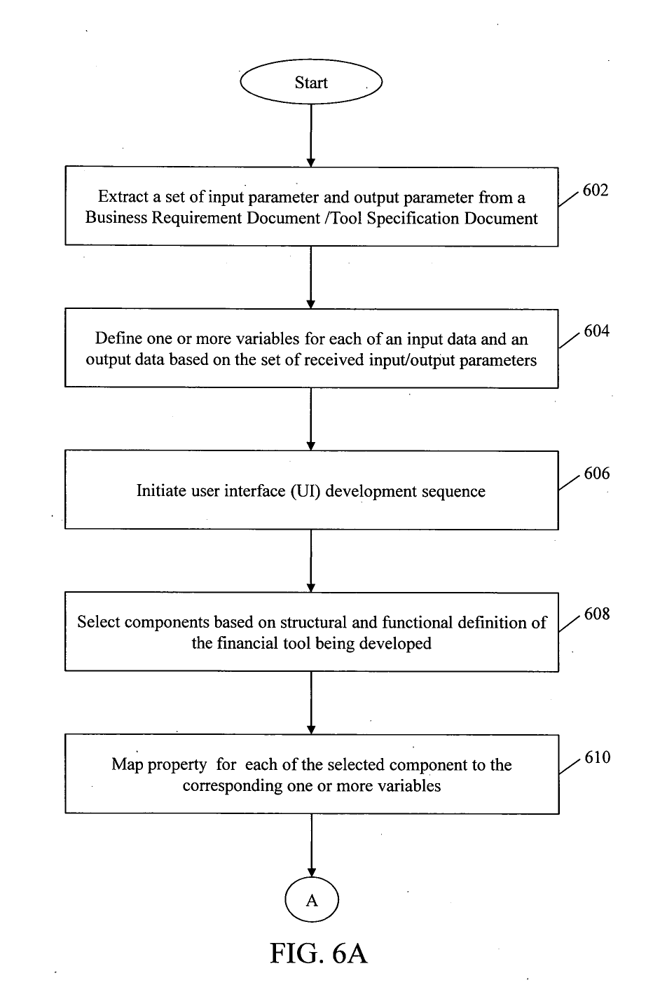

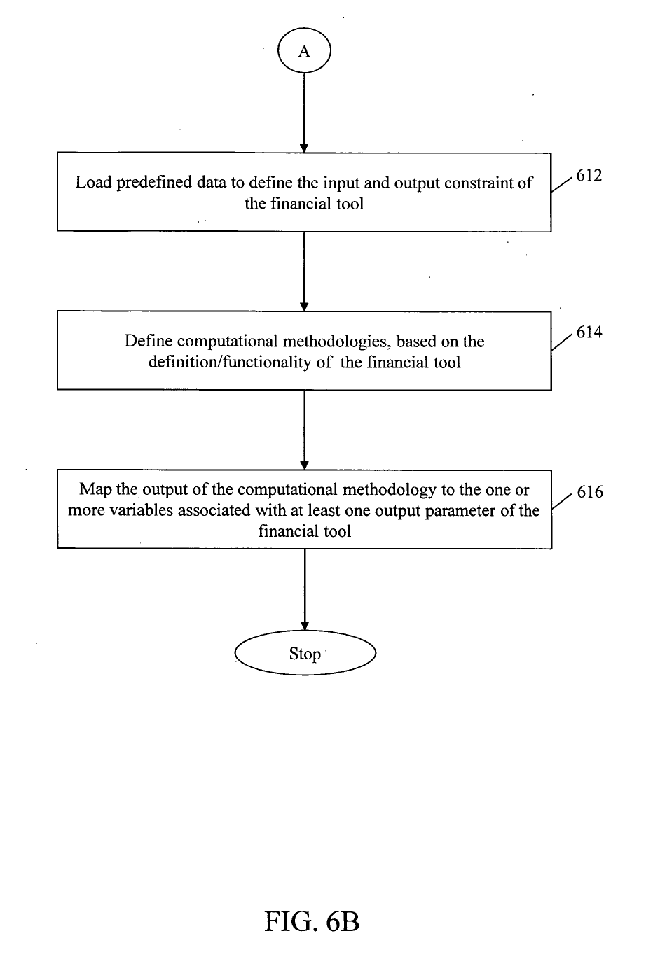

FIG. 6A and 6B illustrate a flowchart to develop a financial tool in an enterprise level framework, in accordance with an embodiment of the invention.

At step 602, a set of input parameters and output parameters are extracted from a Business Requirement Document (BRD)/Tool Specification Document. A developer extracts the set of input/output parameters from the BRD, which in turn defines the requirements of a financial tool being developed. In an embodiment of the present invention, the set of input/output parameters describe the structural and the functional attributes of the financial tool based on the requirement of the business solution. In an exemplary embodiment of the present invention, the set of input/output parameters may include, default input values, type of output parameters, labels corresponding to each of the input/output values, and so forth.

Subsequently, at step 604, one or more variables are assigned for each of an input data and an output data respectively based on the extracted set of input/output parameters. In an embodiment of the present invention, a set of variables selected from the one or more variables may be assigned to the input data, which in turn would reflect the input values required for the computation performed in the financial tool being developed. Additionally, a set of variables selected from the one or more variables may be assigned to the output values which in turn would project the processed data.

At step 606, user interface (UI) development sequence is initiated. After the one or more variables corresponding to the input parameter and the output parameter are defined, UI development sequence is initiated by the enterprise level framework. The set of input/output parameters define the functionality of the tool. Thereafter, a virtual layout of the user interface is generated based on the functionality of the financial tool being developed. For example, in case the set of input/output parameters define the structural and functional attributes of a ‘loan repayment calculator’, then the user interface layout includes at least one panel for input data required for receiving the input values and at least one panel for output data for projecting the processed output. It may be apparent to a person skilled in the art that one or more user interface layouts may be implemented based on the requirement of a business solution.

Thereafter, at step 608, various components are selected based on structural and functional definition of the financial tool being developed. The received set of input/output parameters defines the structural and functional attributes of a financial tool. Correspondingly, respective components are selected based on the structural and functional requirements of the financial tool being developed. The user interface includes one or more components to execute various functionality of the financial tool, such as a component to receive input data, a component to project output data, a component to invoke/load the user interface and so forth. In an exemplary embodiment of the present invention, the financial tool being developed may be a ‘loan interest calculator’, the component selected to input data in the financial tool, is a slider component, which in turn is used to select the value (amount) of the loan. Further, the components selected to project the output of the processed data in the financial tool, is a chart component. Furthermore, a component to load/invoke the user interface is a loader component, which in turn invokes the user interface and each of the associated components during the initialization of the financial tool.

At step 610, property of each of the selected components is mapped to the corresponding one or more variables, based on the definition of the financial tool being developed. Once the components are selected for each of the structural and functional attributes of the user interface layout, each of one or more variables is mapped to a selected component, wherein the one or more variables denotes a set of predefined parameters. In an embodiment of the present invention, a developer may define various structural and functional properties to each of the selected components based on the functionality of the financial tool. For example, a component associated with the output panel of the user interface layout may be a chart component. Further the chart component may be defined with a predefined parameter ‘chart type’, which in turn describes the visual presentation feature of a chart, such as a pie chart, bar chart and so forth.

At step 612, predefined data are loaded at the user interface layout to define the input and output constraint of the financial tool. Once the components along with its respective attributes/properties are selected, predefined data are extracted to further define the input/output constraints of the financial tool being developed. In an embodiment of the present invention, the predefined data is extracted from a pre-stored property file. The predefined data sets the quantitative range (minimum and maximum) of the input data and assigns a default input value selected from the predefined range of the input data. It further defines name of each one of the input and output parameter, such as labels of the output chart, name of the respective input categories, and so forth.

In an embodiment of the present invention, a language file is loaded based on the requirement of a business solution. The language file further enables the internationalization of the financial tool being developed. Further, each of the predefined strings used in the user interface of the financial tool, such as label of the charts, predefined tag of the input components, and so forth, is specified in an external file, which in turn is dynamically loaded into the tool. It may be apparent to a person skilled in the art that various language files corresponding to various geographic locations may be loaded into the tool.

At step 614, computational methodologies are defined based on the definition/functionality of the financial tool. The computational methodology of the respective financial tool is based on the requirement of the business solution. In an embodiment of the present invention, a computational methodology may be selected to define a method required to perform mathematical calculation at a financial tool. Furthermore, a combination of pre-stored computational methodologies may be used to derive a unique mathematical calculation methodology. For example, the computational methodologies may include a method to calculate interest of a loan corresponding to a default amount and so forth.

At step 616, the one or more variables associated with at least one output parameter of the financial tool is mapped with the output of the computational methodology. Once the computation methodology of the financial tool is defined, the corresponding output of the computation is mapped to one or more variables assigned to the output parameter. Therefore, once an input data is processed, based on the definition of the financial tool, at least one output parameter is refreshed based on the computed data. In an exemplary embodiment of the present invention, after computing the data using an interest calculation methodology, the output of the calculation steps are further transferred to the one or more variables associated with the at least one output parameter. The one or more variables in turn update the at least one output parameter, such as values depicted in a chart component projecting the result of the interest calculation, and the like.

In an exemplary embodiment of the present invention, a developer presets a default value selected from the min-max range of values associated with the particular input category for default calculation. For example, in case of a ‘loan repayment calculator’ the input parameter depicting the amount of loan is associated with a min-max range of $ 30,000-$ 400,000. The developer selects a value from the allowed range, such as $ 50,000, as a default value. Therefore, when the financial tool is initialized, the financial tool displays the preset default value and the corresponding processed output value in form of a graphical and a textual representation. Further, the output of the calculation is mapped to variables assigned to the output parameters, which in turn are utilized to project the processed data dynamically i.e. it invokes real-time analysis of the calculation. Once the user changes any one of the input parameter in the financial tool, the financial tool correspondingly computes the new output and subsequently updates the graph/chart and the output summary. It may be apparent to a person skilled in the art that various other output structure may be utilized to project the final processed data, such as text information summarizing the key result, a trend chart highlighting the key timeline and so forth, based on the utility of the financial tool.

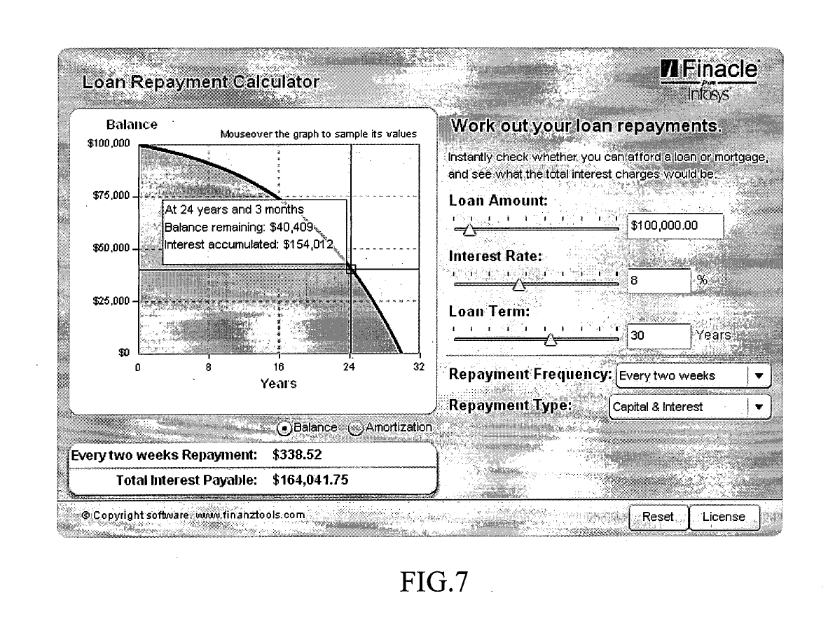

FIG. 7 illustrates a screenshot of a financial tool developed in the enterprise level framework as an exemplary output of the present invention.

The financial tool illustrated in the screenshot is a ‘loan repayment calculator’. As explained in FIG. 2 the predefined layout of a user interface outlines, an input panel, an output panel and an output summary panel. The input panel includes a slider component corresponding to each of a plurality of input parameters, i.e. loan amount, interest rate and loan term. The input panel further includes a dropdown component for each of a repayment frequency and a repayment type. The output panel comprises a chart component outlining a visual representation of the processed information, based on the input parameters and the functionality of the financial tool (loan repayment calculator). The output summary panel highlights the total interest payable and the biweekly repayment amount respectively using a text component.

The financial tool, on being initiated by a user, displays a user interface preloaded with a set of input values and corresponding output data. In an embodiment of the present invention, the set of input values may be pre-stored in the data storage corresponding to the financial tool. In another embodiment of the present invention, the set of input values may be a set of retrieved data corresponding to an end-user account, which in turn would enable the end-user to observe his/her financial position based on the computation performed in the financial tool.

Thereafter the user sets at least one of the loan amount, the interest rate, the loan term, repayment frequency and the repayment type options to a desired value to retrieve processed information. The selection of the input value is performed with the help of the predefined components associated with the input panel respectively, such as a slider button and a drop down button.

On receiving the set of input data, the tool simultaneously calculates the desired result. As defined earlier, the tool uses a Business Logic Layer Module 110 (FIG. 1) in conjunction with one or more classes selected from the Domain Class Module 108 (FIG. 1) to perform computation on the received values. In an exemplary embodiment of the present invention, the ‘loan repayment calculator’ includes a ‘repayment class’, an ‘interest class’, a ‘transaction class’, each of which are selected from the Domain Class Module 108, to process the input data in the financial tool. After computing the data, the tool populates the chart and the output summary based on the computed data. Further, any change in any one of the input parameter, subsequently changes the output of the result, simulating a real-time processing of the input data. This in turn helps the user to experiment with a range of input variables to select a suitable combination of constraints/input parameter based on his preference to further observe, the change in required output data based on his selection. The methodology of the calculation performed in the financial tool is carried out with the help of classes, pre-selected by a developer, and the Business Logic Layer Module 108 (FIG. 1).

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

What is claimed is:

1. A system for developing a financial tool, wherein the system is an enterprise level framework, the system comprising:
a User Interface Module configured to develop a user interface of a financial tool, based on the requirements of a business solution;
a Component Module configured to define the structure and the function of the user interface of the financial tool being developed, based on the requirement of the business solution; and
a Business Logic Layer Module configured to process data in the financial tool, based on the requirement of the business solution.

2. The system of claim 1, wherein the User Interface Module is further configured to select a layout for a user interface of the financial tool being developed, from one or more pre-stored layouts, based on the requirement of the business solution.

3. The system of claim 2, wherein the layout of the user interface selected from the one or more pre-stored layouts comprising at least one of:
an Input Panel configured to receive input data from an end-user to further execute computation in the financial tool;
an Output Panel configured to display the processed output/data of the received input data based on the requirement of the business solution; and
an Output Summary Panel configured to display a summary/outline output based on at least one of the processed output/data of the received input data and the requirement of the business solution.

4. The system of claim 1, wherein the Component Module configured to define the structure and the function of the user interface of the financial tool being developed comprising:
a Loader Component configured to load one or more programs associated with the financial tool and one or more other components associated with the financial tool;
a Slider Component configured to enable an end-user to select an input value with the help of predefined indicators outlined in a graphical user interface bar, wherein each of the predefined indicators corresponds to a predefined value;
a NavBar Component configured to implement navigation functionality in the financial tool, wherein the NavBar Component comprises one or more address links of various parts of the financial tool;
a Chart Component configured to render graphical representation of the processed data computed in the financial tool;
a Dialog window Component configured to implement a popup window used for at least one of, to display communication information to an end-user and to prompt an end-user to input a response; and
a Dropdown Component configured to enable the end-user to select an input value from a list of input values displayed in the financial tool.

5. The system of claim 4, wherein the Component Module is further configured to link at least one component selected from the Component Module to the user interface of the financial tool being developed based on the requirements of the business solution.

6. The system of claim 1, wherein the Business Logic Layer Module configured to process data in the financial tool comprising:
a. a Scenario Class configured to fetch and encapsulate one or more input values required to execute computation in a financial tool being developed;
b. a Simulator Class configured to perform computational simulation on the encapsulated one or more input values based on the requirement of the business solution; and
c. a Result Class configured to encapsulate at least one output of the computed data in the financial tool.

7. The system of claim 6, wherein the Business Logic Layer Module further comprising one or more objects, each of the one or more objects is configured to interact with one or more classes, selected from a Domain Class Module, configured to define methodology of computational functions used by the financial tool, to process the data in the financial tool, based on the requirement of the business solution.

8. The system of claim 1, further comprising a Domain Class Module configured to define the methodology of various computational functions used in the financial tool to further process data, based on the requirement of the business solution.

9. The system of claim 8, wherein the Domain Class Module comprising:
a Repayment Class configured to encapsulate information/data corresponding to a repayment and further defines the methodology to perform the repayment during computation performed in the financial tool;
a Withdrawal Class configured to encapsulate information/data corresponding to a withdrawal and further defines the methodology to perform the withdrawal during computation performed in the financial tool;
an Interest Class configured to encapsulate information/data corresponding to an interest and further defines the methodology to perform at last one of interest transaction and interest calculation during computation performed in the financial tool;
an Account Class configured to encapsulate the present state of an account at a predetermined instance of time;
a Transaction Class configured to encapsulate information/data corresponding to a transaction and further defines the methodology to perform the transaction during computation performed in the financial tool; and
a Projection Class configured to encapsulate a record of financial activities.

10. The system of claim 9, wherein each of the classes included in the Domain Class Module is selected based on a respective functional requirement of the financial tool, defined by the requirement of the business solution.

11. The system of claim 1, further comprising an Application Programming Interface (API) configured to retrieve data from at least one of input data provided by an end-user and received data from an external data source, to further process the retrieved data in the financial tool, based on the requirement of the business solution.

12. The system of claim 11, wherein the Application Programming Interface (API) is a JavaScript API.

13. The system of claim 11, wherein the Application Programming Interface (API) is further configured to enable a developer to embed the financial tool into one or more financial tools being developed.

14. A system for developing a financial tool, wherein the system is an enterprise level framework, the system comprising:
a User Interface Module configured to develop a user interface of a financial tool, based on the requirements of a business solution;
a Component Module configured to define the structure and the function of the user interface of the financial tool being developed, based on the requirement of the business solution;
a Business Logic Layer Module configured to process data in the financial tool, based on the requirement of the business solution; and
an Application Programming Interface (API) configured to retrieve data from at least one of input data provided by an end-user and received data from an external data source, to further process the retrieved data in the financial tool, based on the requirement of the business solution.

15. A method for developing a financial tool in an enterprise level framework, the method comprising:
receiving one or more parameters from a business requirement document (BRD), wherein the BRD describes the structural and functional attributes of the financial tool being developed;
initiating user interface development sequence based on the received one or more parameters;
linking one or more components to the financial tool, wherein each of the one or more components defines a functional and structural attribute of the financial tool, based on the received one or more parameters; and
defining a method to process data in the financial tool, based on the received one or more parameters.

16. The method of claim 15, wherein the one or more parameters comprises at least one of a set of input/output parameters based on the requirement of the financial tool being developed, the functional requirements of the financial tool being developed, and the structural layout of the financial tool being developed.

17. The method of claim 15, further comprising:
selecting a layout of a predefined user interface based on the received one or more parameters corresponding to the financial tool being developed; and
linking each of the one or more components to the selected layout of the user interface based on the received one or more parameters corresponding to the financial tool being developed.

18. The method of claim 15, wherein defining the method to process data in the financial tool further selects one or more predefined computational methodologies, based on the requirement of the business solution.
